(19) United States
(12) Patent Application Publication
(10) Pub. No.: US 2019/0081975 A1
(43) Pub. Date: Mar. 14, 2019

(54) INCREASING PRIVACY AND SECURITY LEVEL AFTER POTENTIAL ATTACK

(71) Applicant: Facebook, Inc., Menlo Park, CA (US)

(72) Inventor: Oleg Iaroshevych, London (GB)

(21) Appl. No.: 15/705,190

(22) Filed: Sep. 14, 2017

(51) Int. Cl. H04L 29/06; G06F 21/55

(52) U.S. Cl. CPC H04L 63/1441; G06F 21/554; H04L 63/1425; H04L 63/1433; H04L 63/083; G06F 21/552

(57) ABSTRACT

An indication that a computer security of a user account has been potentially compromised is received. In response to the indication that the computer security of the user account has been potentially compromised, a privacy setting for the user account is automatically modified to increase a sharing restriction on a content of the user account.

### BACKGROUND OF THE INVENTION

Online software services traditionally address a security threat by locking a potentially compromised account and/or requiring a user to reset the account password. One typical method of identifying a potential attack is by detecting multiple failed login attempts. For example, a malicious user may attempt to gain unauthorized access to a user account by attempting to log into the account by guessing the password. After multiple failed attempts, the online service may determine that the account may be compromised and disable all access to its services from the account. In some situations, the user of the account is required to reset the password before regular access to the account's online services is restored. In some scenarios, a malicious user may not actually gain access to the account, however, the user's account is nevertheless disabled due to the security threat detected by failed login attempts. Traditional security response techniques do not address the concern based on a potential security threat that the user has with respect to future attacks and the potential for an unauthorized user to regain access to a previously compromised account for malicious reasons. In the case where unauthorized access occurs, a malicious user may use a compromised account to generate spam, spread fake news stories, purchase ads using the stolen account's billing information, and download the account's entire posting history and contacts, among other actions.

### BRIEF DESCRIPTION OF THE DRAWINGS

Various embodiments of the invention are disclosed in the following detailed description and the accompanying drawings.

FIG. 1 is a block diagram illustrating an example of a communication environment between a client and a server for automatically adjusting privacy and security levels after a potential attack.

FIG. 2 is a functional diagram illustrating a programmed computer system for automatically adjusting privacy and security levels after a potential attack in accordance with some embodiments.

FIG. 3 is a flow diagram illustrating an embodiment of a process for automatically adjusting privacy levels after a potential attack.

FIG. 4 is a flow diagram illustrating an embodiment of a process for automatically adjusting privacy levels after a potential attack.

FIG. 5 is a flow diagram illustrating an embodiment of a process for automatically adjusting privacy and security levels after a potential attack.

FIG. 6 is a flow diagram illustrating an embodiment of a process for automatically adjusting privacy and security levels after a potential attack.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Automatically adjusting privacy and security levels after a potential attack on an online software service is disclosed. For example, a potential computer security threat is identified and an indication of the threat is received by the online service. A potential computer security threat may be identified using a threat detection mechanism or reported by a user. An example threat detection mechanism may monitor failed login attempts, the location from which the attempts originate, and/or the rate of attempts. In response to an indication of a potential security threat, actions are taken in case the user's account is compromised. For example, a malicious user may have gained unauthorized access to a user's account and it is desirable to minimize the impact of the unauthorized access. In the case where unauthorized access occurs, a malicious user may use a compromised account to generate spam, spread fake news stories, purchase ads using the stolen account's billing information, and download the account's entire posting history and contacts, among other actions. The indication of a potential security threat is used to automatically modify the privacy settings of the user account to increase restrictions on the user's ability to share content. For example, for a social media service, a potentially compromised account may have one or more privacy settings automatically modified when a threat is identified. By modifying the privacy settings, the privacy level of the account may be adjusted to restrict sharing. For example, the adjusted privacy level may restrict certain content sharing capabilities such as generating new posts and/or purchasing advertisements on the online service. Another example of a sharing restriction is limiting the scope of sharing available for the user account. For example, in one scenario, the user's account may only share content with established contacts or friends and not with users that are more than one degree of separation from the user such as a friend of a friend or the general public. In some scenarios, the increased sharing privacy setting is temporary and the privacy setting is returned to the pre-threat setting once a certain time duration has passed.

In some embodiments, an online software service receives an indication that the computer security of a user account has been potentially compromised. For example, a security threat detection mechanism monitors failed login attempts and identifies that a user account is under attack. In response to the indication that the computer security of a user account has been potentially compromised, the online service automatically modifies the privacy setting for the user account. For example, each user account has one or more associated privacy settings. The privacy settings are used to configure the privacy settings for the particular user separate from other users of the system. In various embodiments, the privacy settings control how user content is shared by the online software service with other users. The privacy settings may be modified to increase a privacy level and introduce sharing restrictions for content of the user account. For example, a restriction may be placed on sharing content by the user of the account. As another example, for the potentially compromised account, the account user may no longer be able to create new posts and share with all other users of the software service. As yet another example, the user may no longer be able to create, purchase, and/or publish new advertisements from the online service. In these examples, new posts that may be spam and fraudulently purchased advertisements are prevented from being shared with users of the online service.

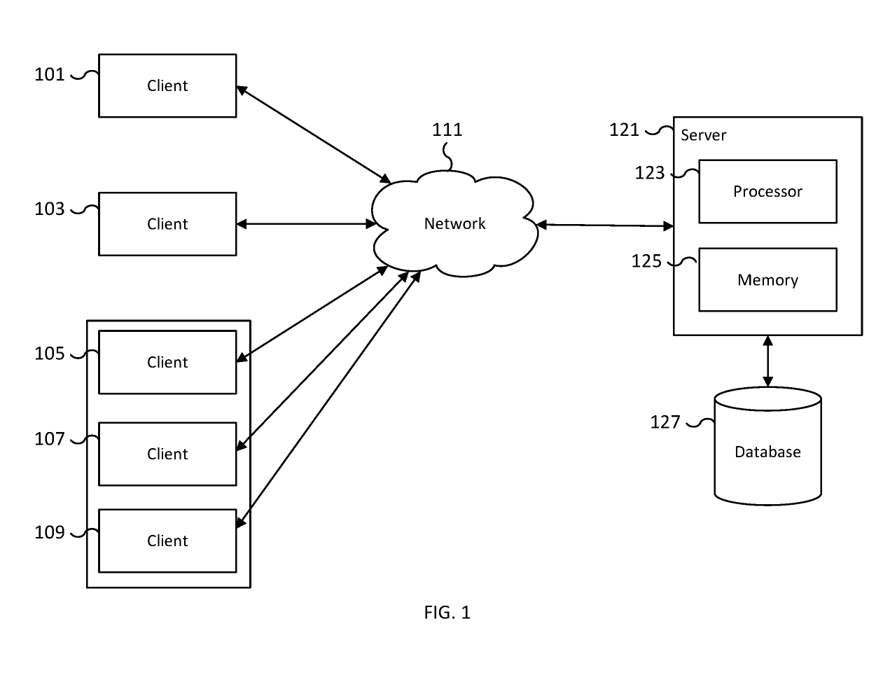

FIG. 1 is a block diagram illustrating an example of a communication environment between a client and a server for automatically adjusting privacy and security levels after a potential attack. In the example shown, clients 101, 103, 105, 107, and 109 are network computing devices for accessing online software services and server 121 is a server for providing an online software service. Examples of network computing devices include but are not limited to a smartphone device, a desktop computer, a tablet, a laptop, smart TV, a virtual reality headset, and a gaming console. Clients 105, 107, and 109 are grouped together to represent network devices accessing server 121 from the same sub-network. As examples, clients 105, 107, and 109 may be devices from the same company network, same university network, or same home network. In some embodiments, clients on the same sub-network correspond to clients from the same general physical location. Clients 101 and 103 are network devices accessing server 121 from their own respective networks. Clients 101, 103, 105, 107, and 109 connect to server 121 via network 111. Examples of network 111 include one or more of the following: a mobile communication network, the Internet, a direct or indirect physical communication connection, a Wide Area Network, a Storage Area Network, and any other form of connecting two or more systems, components, or storage devices together. Server 121 uses processor 123 and memory 125 to process and respond to requests from clients 101, 103, 105, 107, and 109 and to automatically adjust privacy and security levels after a potential attack. In some embodiments, content from and for clients 101, 103, 105, 107, and 109 are stored and hosted from database 127. In some embodiments, user security and privacy settings are stored in database 127.

Users connect to server 121 via clients 101, 103, 105, 107, and 109. The service provided by server 121 is an online software service. As one example, server 121 may provide a social media service that allows users to connect to other users online and to share content such as text, photos, and video. In some embodiments, the software service provides its users with different granularities for sharing content. For example, a user may share content with an approved contact, a group of approved contacts, a group of users of the service, and/or all users of the service. In various embodiments, different granularities of sharing, determining the target audience of sharing, and/or determining the visibility of shared content are available. In some embodiments, the software sharing granularities are defined by which users may access the shared content. For example, restrictions set for sharing may allow an approved contact, a group of approved contacts, a group of users of the service, and/or all users of the service to view content shared by the user. In various embodiments, different types of content may be shared. Examples of content the user may share include content authored by the user as well as content authored by another party. Examples of content include written content and digital media. Digital media may include media in the form of photos, video, drawings, audio, and music. Another example of shared content is the user's profile, which may include a user's name, photo, location, phone number, education, and other identifying characteristics. As another example, content may include digital media advertisements that are shared with a targeted audience.

Users of clients 101, 103, 105, 107, and 109 may be authorized or unauthorized users of the service offered by server 121. An authorized user of a client is typically allowed access to the software service by authenticating oneself to the service offered by server 121. Authentication typically requires identifying the user via information such as a user account and password combination. It is common for unauthorized users to attempt to gain access to a user's account. In some scenarios, an unauthorized user will attempt to guess the password of a user's account. In other scenarios, an unauthorized user will attempt to gain access to a user's account by exploiting a potential flaw in the software service of server 121. In various embodiments, the software service of server 121 will attempt to detect these security threats and provide an indication that the targeted account may be potentially compromised. In some embodiments, the user of the software service may indicate that an account, including the user's account or an account belonging to someone else, may be potentially compromised. For example, a user may believe his or her password was lost or stolen and report the potential of a security threat to the software service offered by server 121. As another example, a user may believe a friend's account is generating spam and report a potential security threat related to the friend's account to the software service offered by server 121.

In the event a potential security threat is identified, server 121 receives an indication that the computer security of the user account associated with the threat has been potentially compromised. In some scenarios, a malicious user may attempt to use the compromised account to distribute spam. In response to the security threat indication, the software of server 121, using processor 123 and memory 125, automatically modifies one or more privacy settings for the potentially compromised user account to increase the sharing restriction on content of the user account. In some embodiments, implementing one or more sharing restrictions corresponds to increasing the privacy level of the account. For example, the user account may no longer be allowed to share content with the entire public. In various embodiments, the target audience for the shared content may be modified to limit the exposure or visibility of shared content. As another example, a modified target audience may include only established contacts or friends, thus excluding users that are more than one degree of separation from the user such as a friend of a friend and the general public. Other examples of restricting sharing and/or raising the privacy level include limiting sharing to existing groups the user belongs to and/or removing the ability to join new groups or to add new contacts or friends. An additional example of restricting sharing and/or raising the privacy level includes removing the ability for the user account to display advertisements, which in some embodiments includes removing the ability to purchase and/or create new advertisements and/or the ability to modify existing advertisements.

In various embodiments, the components shown in FIG. 1 may exist in various combinations of hardware machines. Although single instances of components have been shown to simplify the diagram, additional instances of any of the components shown in FIG. 1 may exist. For example, server 121 may include one or more servers providing a software service and for automatically adjusting privacy and security levels after a potential attack. Components not shown in FIG. 1 may also exist.

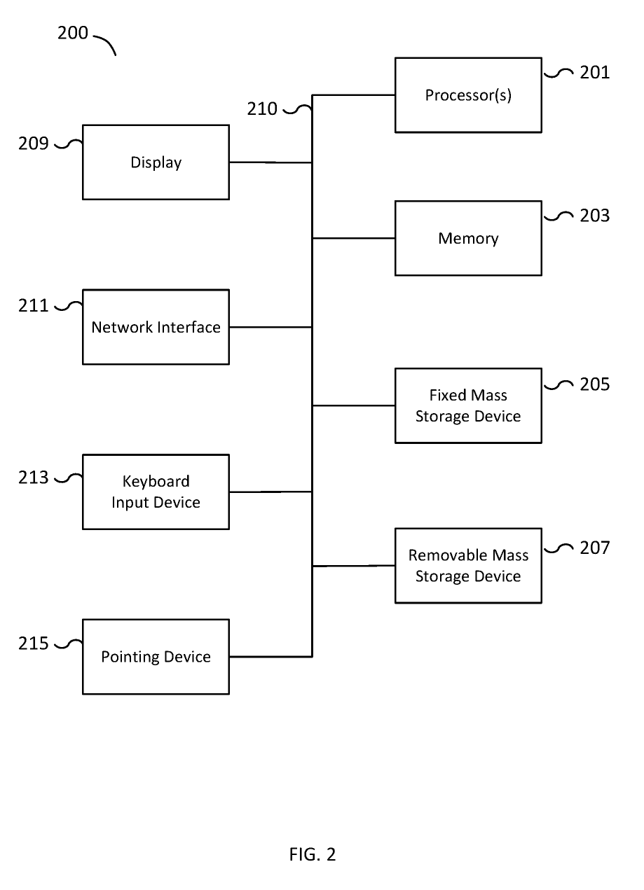

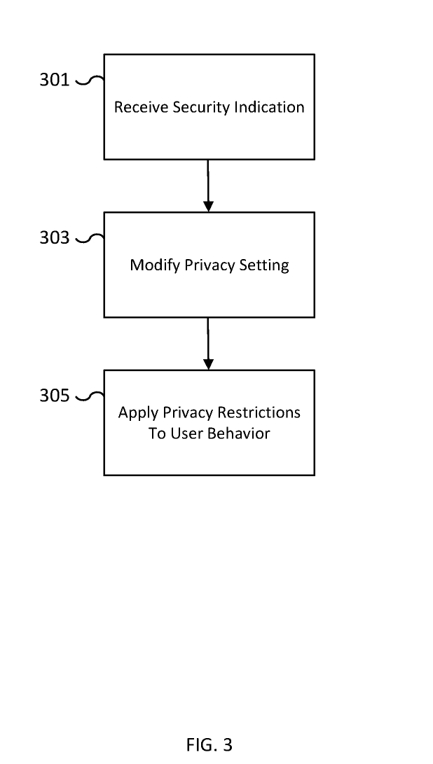

FIG. 2 is a functional diagram illustrating a programmed computer system for automatically adjusting privacy and security levels after a potential attack in accordance with some embodiments. As will be apparent, other computer system architectures and configurations can be used to perform the automatic adjustment of privacy and security levels after a potential attack. In some embodiments, computer system 200 is a virtualized computer system providing the functionality of a physical computer system. Computer system 200, which includes various subsystems as described below, includes at least one microprocessor subsystem (also referred to as a processor or a central processing unit (CPU)) 201. For example, processor 201 can be implemented by a single-chip processor or by multiple processors. In some embodiments, processor 201 is a general purpose digital processor that controls the operation of the computer system 200. Using instructions retrieved from memory 203, the processor 201 controls the reception and manipulation of input data, and the output and display of data on output devices (e.g., display 209). In some embodiments, processor 201 includes and/or is used to provide functionality for receiving an indication that a computer security of a user account has been potentially compromised and automatically modifying a privacy setting for the user account to increase a sharing restriction on content of the user account. In some embodiments, computer system 200 is used to provide element 121 of FIG. 1. In some embodiments, processor 201 includes and/or is used to provide element 123 with respect to FIG. 1 and/or performs the processes described below with respect to FIGS. 3, 4, 5, and 6.

Processor 201 is coupled bi-directionally with memory 203, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 201. Also as is well known in the art, primary storage typically includes basic operating instructions, program code, data, and objects used by the processor 201 to perform its functions (e.g., programmed instructions). For example, memory 203 can include any suitable computer-readable storage media, described below, depending on whether, for example, data access needs to be bi-directional or uni-directional. For example, processor 201 can also directly and very rapidly retrieve and store frequently needed data in a cache memory (not shown).

A removable mass storage device 207 provides additional data storage capacity for the computer system 200, and is coupled either bi-directionally (read/write) or uni-directionally (read only) to processor 201. For example, storage 207 can also include computer-readable media such as flash memory, portable mass storage devices, magnetic tape, PC-CARDS, holographic storage devices, and other storage devices. A fixed mass storage 205 can also, for example, provide additional data storage capacity. Common examples of mass storage 205 include flash memory, a hard disk drive, and an SSD drive. Mass storages 205, 207 generally store additional programming instructions, data, and the like that typically are not in active use by the processor 201. Mass storages 205, 207 may also be used to store user-generated content and digital media for use by computer system 200. It will be appreciated that the information retained within mass storages 205 and 207 can be incorporated, if needed, in standard fashion as part of memory 203 (e.g., RAM) as virtual memory.

In addition to providing processor 201 access to storage subsystems, bus 210 can also be used to provide access to other subsystems and devices. As shown, these can include a display 209, a network interface 211, a keyboard input device 213, and pointing device 215, as well as an auxiliary input/output device interface, a sound card, speakers, additional pointing devices, and other subsystems as needed. For example, the pointing device 215 can be a mouse, stylus, track ball, or tablet, and is useful for interacting with a graphical user interface.

The network interface 211 allows processor 201 to be coupled to another computer, computer network, or telecommunications network using one or more network connections as shown. For example, through the network interface 211, the processor 201 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 201 can be used to connect the computer system 200 to an external network and transfer data according to standard protocols. For example, various process embodiments disclosed herein can be executed on processor 201, or can be performed across a network such as the Internet, intranet networks, or local area networks, in conjunction with a remote processor that shares a portion of the processing. Additional mass storage devices (not shown) can also be connected to processor 201 through network interface 211.

An auxiliary I/O device interface (not shown) can be used in conjunction with computer system 200. The auxiliary I/O device interface can include general and customized interfaces that allow the processor 201 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above and magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 2 is but an example of a computer system suitable for use with the various embodiments disclosed herein. Other computer systems suitable for such use can include additional or fewer subsystems. In addition, bus 210 is illustrative of any interconnection scheme serving to link the subsystems. Other computer architectures having different configurations of subsystems can also be utilized.

FIG. 3 is a flow diagram illustrating an embodiment of a process for automatically adjusting privacy levels after a potential attack. In some embodiments, the process of FIG. 3 is implemented on server 121 of FIG. 1. In the example shown, at 301, a security indication is received. In some embodiments, a potential security threat is determined automatically by the software service, for example, using a security threat detection mechanism. In some embodiments, threat determination is based on failed or suspicious login attempts, the location from which login attempts originate, the device from which login attempts originate, and/or the activity rate of user login attempts. In some embodiments, once the activity rate of a user account exceeds a threshold, a security threat is determined to exist and results in a security indication. In various embodiments, once a potential security threat is detected, a security indication is triggered. An example of a security threat includes repeated failed login attempts on a user account. Another example includes multiple failed login attempts for different user accounts from the same client device or sub-network.

In some embodiments, a security threat may be determined while the user is logged into an account. In the event the user activity exceeds a threshold, a security threat is determined to exist and results in a security indication. For example, in the event the number of posts and/or advertisements a user generates exceeds a threshold, the system may determine the activity is spam. Based on the determination that a security threat exists, a security indication is automatically triggered to indicate that the computer security of the user account has been potentially compromised.

In some embodiments, the security indication is received via a user creating a notification of a security threat. In some instances, a user identifies a potential security threat related to his or her own account. In other instances, a user identifies a potential security threat related to another user's account. For example, the user may have misplaced, lost, or had his or her password stolen. In response to the compromised password, the user notifies the software server that his or her password is compromised, resulting in a security indication. In some embodiments, the user interacts with an online web interface to report a potential security threat. For example, the software service may provide a particular URL or webpage a user may access to notify the software service of a potential security threat. In some embodiments, the security indication is received for an account via another user suspecting a potential security threat. For example, in the event a user notices that a contact's account is generating spam, the user may notify the software system of a potential security threat related to the contact's account. In various embodiments, a security threat may be detected via the online service and/or one or more users.

At 303, the privacy setting of the potentially compromised user account is modified. In some embodiments, one or more privacy settings for each potentially compromised user account corresponding to the security indication are modified. A user account's privacy settings include, among other things, settings for the target audience for content sharing and may be based on the user's contacts, friends, group memberships, and other similar associations. Different values for the target audience of content sharing may include a very narrow set of recipients to a very large set of recipients. Examples of target audiences may include an individual user from the user's contacts, any individual user of the online service, a subset of the user's contacts or friends, one or more groups the user belongs to, one or more users within a certain degree of separation from the user, and/or all users of the online service. In some embodiments, the modification of one or more privacy settings restricts the ability for the user to export or download previously shared content such as posts, photos, media, and contacts. In some embodiments, the modification of the privacy setting restricts the user from creating, purchasing, sharing, and/or modifying advertisements. In some embodiments, the modification of the privacy setting restricts the user from modifying groups the user belongs to such as adding additional groups and/or modifying membership to existing groups. In some embodiments, the modification of the privacy setting restricts the user from modifying his or her approved contacts or friends. In some embodiments, the modification of the privacy setting restricts the user's ability to interact with other users on the social media platform such as restricting the ability for the user to participate in tagging people in photos. In some embodiments, the sharing restrictions may limit the ability, visibility, and/or exposure of shared content but do not prohibit the user from sharing content. For example, the user may still tag and create new posts, but the tags and visibility of the posts may be limited to an approved set of contacts. In this manner, the user may still participate in social aspects and features of the software service while minimizing the exposure and risk that content shared is spam. In various embodiments, the privacy level of an account may correspond to certain privacy settings. In various embodiments, the privacy settings are determined automatically by the software service.

In some embodiments, the privacy settings control how and what information is presented to other users. For example, the privacy settings may control and limit presenting profile information, including profile photos, to other users. In some embodiments, privacy settings may be used to limit and/or prevent presenting profile information including profile photo(s), home town, work history, relationship status, school name, birthday information, and other personal profile information. In some scenarios, a malicious user may attempt to gather personal details related to a user from the user's profile information. The malicious user may then use the information in order to compromise an account on the software service or the targeted user's accounts on third-party services. In various embodiments, the privacy settings associated with personal profile information are modified to prevent the information from being shared.

In some embodiments, the software service automatically generates content associated with the user, separate from user-authored content, which may be limited by privacy settings. For example, the software service may display the total number of contacts or friends a user has next to a user's profile information. As another example, the software service may assign and display a location for a new post or photo shared by the user. In various embodiments, auto-generated content may be limited or completely excluded by the privacy settings. For example, a user's account may be restricted from sharing auto-generated content to certain sets of users based on the privacy settings.

In some embodiments, the privacy settings control how and what information is shared with search engines and presented in search results. For example, a software service may allow users to search other users via profile information. In some embodiments, the privacy settings may be used to disable the ability to search for a user by email, phone number, and/or other identifying information. In the event a user changes his or her email address and the privacy settings have disabled the ability for search results to display the user's email address, a malicious user will be unable to verify the new email address using the search functionality. In various embodiments, privacy settings may exclude user information from being shared with search engines including outside search engines.

In some embodiments, the privacy settings for a user account include privacy settings for third-party software services. For example, a user account for the software service may share a user account or be related to a user account on a second software service. In the event an account on the first software service is compromised, the change in privacy settings for the user's account on the first software service may also restrict the user's account on the second software service. For example, the privacy settings of a potentially compromised user account may be modified to restrict the user's ability to share content and/or interact with users on a second software service.

In some embodiments, at 303, a dialog is displayed to the user to inform the user of different options for modifying the account's privacy settings. For example, the dialog may list options to setting the visibility of shared content, such as limiting shared content to approved contacts or friends and groups the user belongs to, among other options. As another example, the dialog may list the option to disable the purchase of advertisements. In some embodiments, the software service suggests appropriate sharing restrictions to the user based on the type of threat detected. In various embodiments, the selected options from the dialog are used to modify the user's privacy settings.

In some embodiments, at 303, the user is notified that the account's privacy settings are being modified. For example, in some embodiments, the user may receive a window dialog message indicating that a potential security threat was detected and that the user's privacy settings are being modified. In some embodiments, the message includes a description of the restrictions implemented by adjusting the privacy settings such as particular limitations on content sharing. In some embodiments, the user interface for the software service is modified to reflect the modifications to the privacy settings. For example, a user interface element or visual indicator, such as a shield icon, may be displayed along side the user's content and/or profile. In some embodiments, the user is notified via a communication channel such as by email, SMS, push notification, in-app notification, or other appropriate methods. In various embodiments, more than one form of notification may be used to inform the user of privacy modifications.

At 305, the privacy restrictions based on the privacy settings modified at 303 are applied to the account user's behavior. For example, in the event the target audience for content sharing is restricted at 303, when a user shares content, the content will only be shared with the new target audience. In some embodiments, the target audience of previously shared content is similarly modified to restrict the target audience. As another example, in the event the privacy settings disable the ability to download the user's history, which may include written posts, photos, and other shared entries, the user's account will no longer be able to export the user's history. As yet another example, in the event the ability to purchase and/or display advertisements from the user's account is disabled by sharing restrictions, the user's account will no longer be able to purchase and/or display advertisements. In some embodiments, the sharing restrictions are applied only to content shared after the privacy settings are modified. In some embodiments, the sharing restrictions are applied to both content shared prior to and after the privacy settings are modified. In some embodiments, user content shared older than a set age, such as one year, is restricted in its visibility and is to be made private.

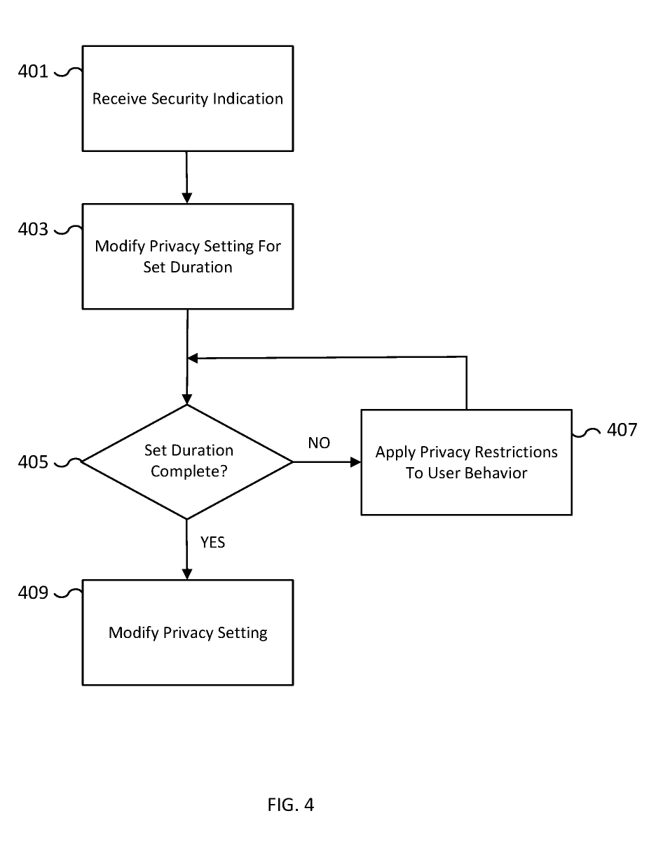

FIG. 4 is a flow diagram illustrating an embodiment of a process for automatically adjusting privacy levels after a potential attack. In some embodiments, the process of FIG. 4 is implemented on server 121 of FIG. 1. In some embodiments, the process at 401 may be performed as part of the process of 301 of FIG. 3, the process at 403 may be performed as part of the process of 303 of FIG. 3, and the process at 407 may be performed as part of the process of 305 of FIG. 3.

In the example shown, at 401, a security indication is received. In some embodiments, the security threat is detected by server 121. In various embodiments, the security threat is identified by a user of the service provided by server 121. At 403, a privacy setting is modified for a set duration. In some embodiments, the set duration is determined by the system. In various embodiments, the set duration is determined by the user of the potentially compromised account. For example, the user may be provided with a user interface to select the set duration for increased privacy. In one embodiment, the user is provided a suggestion of default durations such as three days, one week, two weeks, or one month corresponding to the length of time the modified privacy settings are active. In various embodiments, the modified privacy settings increase the privacy level of the account and/or restrict the sharing of content by the user account.

At 405, it is determined whether the elapsed time since the privacy settings have been modified has exceeded the duration set at 403. In the event the duration has not completed, processing continues to 407. At 407, privacy restrictions are applied to the user's behavior. For example, in the event the target audience for content sharing is restricted by the modified privacy setting at 403, when a user shares content, the content will only be shared with the new target audience. In some embodiments, the target audience of previously shared content is similarly modified to restrict the target audience. As another example, in the event the privacy settings disable the ability to download the user's history, which may include written posts, photos, and other shared entries, the user's account will no longer be able to export the user's history. As yet another example, in the event the ability to purchase and/or display advertisements from the user's account is disabled by sharing restrictions, the user's account will no longer be able to purchase and/or display advertisements. In some embodiments, the sharing restrictions are applied only to content shared after the privacy settings are modified. In some embodiments, the sharing restrictions are applied to both content shared prior to and after the privacy settings are modified at 403. From 407, processing loops back to 405 to determine whether the elapsed time since the privacy settings have been modified has exceeded the duration set at 403. In various embodiments, the loop between 405 and 407 may be implemented using a timer, a callback, or other similar techniques.

In the event at 405 that the duration set at 403 has completed, processing continues to 409. At 409, one or more privacy settings are modified. In some embodiments, the privacy settings are returned to their original settings prior to the modification at 403. For example, in the event that sharing restrictions are introduced at 403, the restrictions are removed at 409. In some embodiments, the privacy settings are modified to decrease the sharing restrictions on sharing content. In various embodiments, the reduced sharing restrictions correspond to reducing the privacy level of the account.

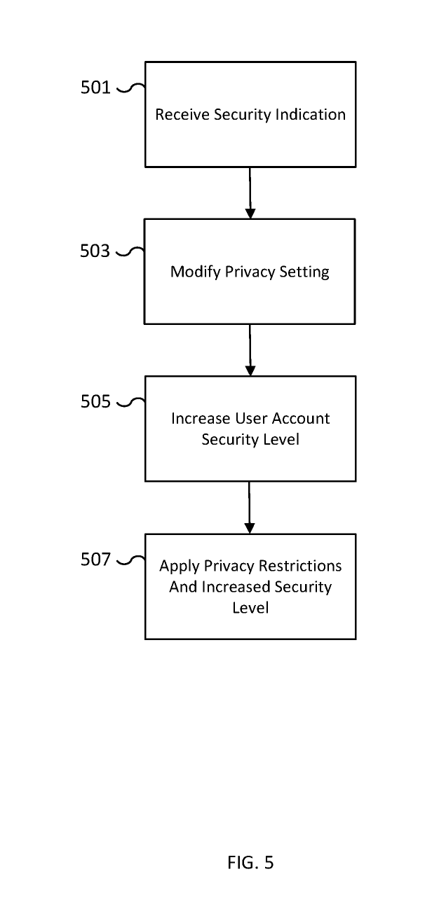

FIG. 5 is a flow diagram illustrating an embodiment of a process for automatically adjusting privacy and security levels after a potential attack. In some embodiments, the process of FIG. 5 is implemented on server 121 of FIG. 1. In some embodiments, the process at 501 may be performed as part of the process of 301 of FIG. 3, the process at 503 may be performed as part of the process of 303 of FIG. 3, and part of the process at 507 may be performed as part of the process of 305 of FIG. 3.

In the example shown, at 501, a security indication is received. In some embodiments, the security threat is detected by server 121. In various embodiments, the security threat is identified by a user of the service provided by server 121. At 503, the privacy setting is modified. In some embodiments, one or more privacy settings for each potentially compromised user account corresponding to the security indication are modified. A user account's privacy settings include, among other things, settings for the target audience for content sharing and may be based on the user's contacts, friends, group memberships, and other similar associations. At 505, the user's account security level is increased. In some embodiments, the security level increase may include enabling two or multi-factor authentication. For example, a user may be required to enter a PIN from a mobile device in addition to the user's password to log in. As another example, multi-factor authentication may require entering information received from an SMS or email in addition to knowing the user's password to obtain access to the user's account.

In some embodiments, the user is presented with a dialog window and/or receives one or more notifications to inform the user that the security level will be increased. The notification may be by email, SMS, push notification, in-app notification, or other appropriate methods. In various embodiments, the dialog window allows the user to select a duration of time that the security level will be increased for before returning to the original or a lower security level. In some embodiments, the user may select from one or more different enhanced security levels or security measures. For example, the user may enable multi-factor authentication and/or enable login alerts. Another example of an increased security level restriction includes restrictions on locations or devices from which the user may log in from. For example, a higher security level may only allow the user to log in from the user's phone and from the user's work and home networks. In some embodiments, while accessing the software service during the duration of an increased security level, a visual icon, such as a shield icon, is displayed to the user to reflect the raised security level.

At 507, privacy restrictions and an increased security level are applied to the user account. For example, with respect to privacy restrictions, in the event the target audience for content sharing is restricted by the modified privacy setting at 503, when a user shares content, the content will only be shared with the new target audience. In some embodiments, the target audience of previously shared content is similarly modified to restrict the target audience. As another example, in the event the privacy settings disable the ability to download the user's history, which may include written posts, photos, and other shared entries, the user's account will no longer be able to export the user's history. As yet another example, in the event the ability to purchase and/or display advertisements from the user's account is disabled by sharing restrictions, the user's account will no longer be able to purchase and/or display advertisements. In some embodiments, the sharing restrictions are applied only to content shared after the privacy settings are modified. In some embodiments, the sharing restrictions are applied to both content shared prior to and after the privacy settings are modified at 503.

At 507, the restrictions corresponding to the increased security level are also applied to the user's account. For example, in some embodiments, in the event two-factor authentication is required to export the user's history, the software service will send an email or SMS containing additional information in addition to the user's password to authenticate the user before allowing the user to export the user's history. As another example, in the event the increased security level requires two-factor authentication for user logins, then the user will be required to log in using two-factor authentication for the duration of the increased security level. In some embodiments, based on the security level and/or privacy settings, user content is tagged and/or watermarked to prevent theft. For example, a user's profile photo may have a security/privacy icon overlaid on the photo to discourage a malicious user from using the photo to create a fake account and/or steal the user's identity. Furthermore, user interface elements and visual indicators used to mark the user's content and/or profile help verify the authenticity of the user's identity to both the user and the user's contacts.

In some embodiments, the duration of the increased security level and/or the application of the modified privacy settings is temporary. Once the duration is exceeded, the security level is lowered, for example, returned to the original level prior to raising the security level. Similarly, once the duration is exceeded, the privacy settings are modified and in some embodiments, returned to the pre-modified values. In some embodiments, one or more notifications, such as a sharing restriction expiration notification, and/or dialog windows are sent or presented to the user to inform the user of the modifications. For example, the user may receive an SMS message informing the user that the privacy setting(s) and/or security level of the user's account have been returned to pre-modified values. As another example, the user is presented with a dialog window explaining the changes to the privacy settings and/or security level. In some embodiments, a user interface element or visual indicator displayed in the user interface next to user content and/or the user's profile during the duration of raised privacy settings and/or security levels is no longer displayed.

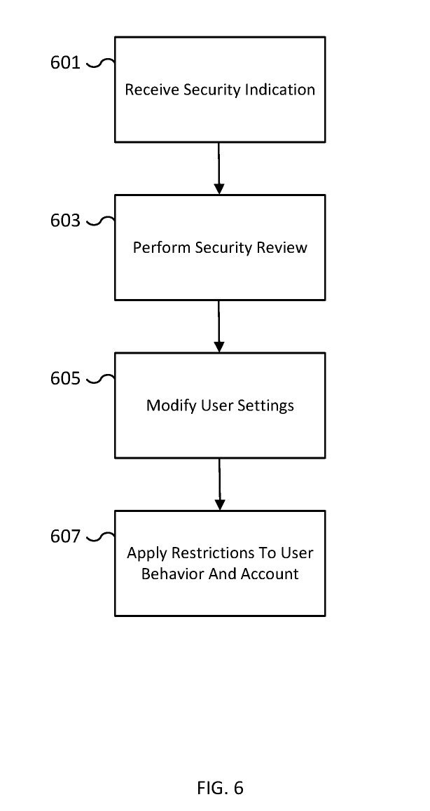

FIG. 6 is a flow diagram illustrating an embodiment of a process for automatically adjusting privacy and security levels after a potential attack. In some embodiments, the process of FIG. 6 is implemented on server 121 of FIG. 1. In some embodiments, the process at 601 may be performed as part of the process of 301 of FIG. 3. In some embodiments, the process at 605 may be performed as part of the process of 303 of FIG. 3, 503 of FIG. 5, and/or 505 of FIG. 5. In some embodiments, part of the process at 607 may be performed as part of the process of 305 of FIG. 3. In some embodiments, the process at 607 may be performed as part of the process of 507 of FIG. 5.

In the example shown, at 601, a security indication is received. In some embodiments, the security threat is detected by server 121. In various embodiments, the security threat is identified by a user of the service provided by server 121. At 603, a security review is performed. In some embodiments, the security review is a user-interactive security review performed with input from the user. For example, the security review may question the user on past behavior to authenticate that the user is the authorized user. Examples of information that may be confirmed include: the identity of contacts of the user; past login times, locations, browsers, and devices; account information such as account password, date of birth, phone number, email address, etc. and modifications to the account information; installed applications; passwords for installed applications; billing or payment information such as billing address and credit card information; and account activity such as past sharing history including posts and tags. In the examples described, the user must confirm and/or verify the information presented in order to confirm the user's identity. Failing to confirm the information indicates that the login attempt may be unauthorized.

In some embodiments, the security review is performed by the software service without requiring interaction from the user. In some embodiments, the security review may be used to detect malware on the user's device. In the event malware is detected, the user's account may be disabled until the malware is removed. In some embodiments, only a subset of devices is disabled and the account may be accessed by non-disabled devices. For example, only devices with malware detected are disabled and the user may access the account from non-infected devices. The malware detected devices may remain disabled from accessing the user's account until the malware is removed. In some embodiments, the security review displays current active sessions and allows the user to disable any of the existing active sessions. For example, a dialog is displayed presenting devices that are logged into the user's account and the user may log out of any of the listed devices. In various embodiments, a dialog window and message are displayed to the user informing the user that a security review is being performed.

At 605, the user settings are modified. In response to the security indication, the user settings are modified and may include modifying one or more privacy settings and the security level. In some embodiments, raising the privacy setting and security level are performed for only a set duration. Examples of modifying the privacy settings and security level are described above with respect to FIGS. 3-5.

At 607, the restrictions corresponding to the modified user settings in 605 are applied to the account and the user's behavior. In some embodiments, the modified user settings may increase the privacy level and are applied as described above with respect to FIGS. 3-5. In some embodiments, the modified user settings may increase the security level and are applied as described above with respect to FIG. 5. Examples of an increased privacy level include restrictions on content sharing. Examples of an increased security level include requiring two-factor authentication and enabling login alerts. Further examples of applying modified privacy settings and an increased security level are described above with respect to FIGS. 3-5.

In some embodiments, the duration of the modified user settings is temporary. Once a set duration has been exceeded, the user settings may be returned to the original values prior to modification. In the event the user settings include increasing the security and privacy levels, the security and privacy levels may be lowered and/or returned to their original levels prior to the increase performed by modifying the user settings at 605. In some embodiments, one or more notifications, dialog windows, and/or user interface elements or visual indicators in the user interface may be used to reflect the changes in security and privacy levels.

Although the foregoing embodiments have been described in some detail for purposes of clarity of understanding, the invention is not limited to the details provided. There are many alternative ways of implementing the invention. The disclosed embodiments are illustrative and not restrictive.

1. A method, comprising:
receiving an indication that a computer security of a user account has been potentially compromised; and
in response to the indication that the computer security of the user account has been potentially compromised, using a computer processor to automatically modify a privacy setting for the user account to increase a sharing restriction on a content of the user account.

2. The method of claim 1, wherein the indication that the computer security of the user account has been potentially compromised is initiated by a user.

3. The method of claim 1, wherein a system automatically detected that the computer security of the user account has been potentially compromised.

4. The method of claim 1, wherein the indication that the computer security of the user account has been potentially compromised is automatically determined based on a location associated with a user activity.

5. The method of claim 1, wherein the indication that the computer security of the user account has been potentially compromised is automatically determined based on a determination that an activity rate of the user account exceeds a threshold.

6. The method of claim 1, wherein the indication that the computer security of the user account has been potentially compromised is automatically determined based on a user login attempt.

7. The method of claim 1, wherein the content of the user account includes a user-generated content.

8. The method of claim 1, wherein increasing the sharing restriction on the content of the user account does not prohibit sharing of the content of the user account.

9. The method of claim 1, wherein increasing the sharing restriction on the content of the user account limits sharing to a reduced number of other user accounts.

10. The method of claim 1, wherein increasing the sharing restriction on the content of the user account includes disabling an export feature for the user account or restricting sharing with a search engine.

11. The method of claim 1, wherein at least a portion of the increase in the sharing restriction on the content of the user account is for a temporary period of time and after the temporary period of time expires, at least the portion of the increase in the sharing restriction is returned to a previous state prior to the increase.

12. The method of claim 1, wherein at least a portion of the increase in the sharing restriction on the content of the user account is limited to a specified duration of time.

13. The method of claim 1, wherein modifying the privacy setting for the user account to increase the sharing restriction on the content of the user account includes providing to a user a sharing restriction modification notification.

14. The method of claim 13, wherein the sharing restriction modification notification is a sharing restriction modification suggestion associated with one or more time duration options or a sharing restriction expiration notification.

15. The method of claim 1, wherein modifying the privacy setting for the user account to increase the sharing restriction on the content of the user account includes automatically implementing an automatically determined sharing restriction modification and providing a notification of the sharing restriction modification to a user of the user account.

16. The method of claim 1, further comprising in response to the indication that the computer security of the user account has been potentially compromised, performing a user-interactive security review of the user account.

17. The method of claim 16, wherein performing the user-interactive security review includes requesting a user to confirm one or more of the following: a user activity, a user device usage, a login activity, a user application, a user profile modification, a user contact, a payment information, or a security setting.

18. A method of claim 1, further comprising in response to the indication that the computer security of the user account has been potentially compromised, automatically modifying the user account to increase a security level of the user account.

19. A system comprising:
a processor; and
a memory coupled with the processor, wherein the memory is configured to provide the processor with instructions which when executed cause the processor to:
receive an indication that a computer security of a user account has been potentially compromised; and
in response to the indication that the computer security of the user account has been potentially compromised, automatically modify a privacy setting for the user account to increase a sharing restriction on a content of the user account.

20. A computer program product, the computer program product being embodied in a non-transitory computer readable storage medium and comprising computer instructions for:
receiving an indication that a computer security of a user account has been potentially compromised; and
in response to the indication that the computer security of the user account has been potentially compromised, automatically modifying a privacy setting for the user account to increase a sharing restriction on a content of the user account.
